(19) United States
(12) Patent Application Publication
(10) Pub. No.: US 2018/0332874 A1
(43) Pub. Date: Nov. 22, 2018

(54) Method for cleaning and disinfection

(71) Applicant: Douglas Kelley, Wenatchee, WA (US)

(72) Inventor: Douglas Kelley, Wenatchee, WA (US)

(21) Appl. No.: 15/599,354

(22) Filed: May 18, 2017

(51) Int. Cl. A23L 5/00; C11D 10/04; C11D 11/04; C11D 1/62; C11D 3/395; C11D 3/04; C11D 1/04; B08B 3/04; A23B 7/154

(52) U.S. Cl. CPC A23L 5/57; C11D 10/04; C11D 11/04; C11D 1/62; A23B 7/154; C11D 3/042; C11D 1/04; B08B 3/04; C11D 3/3956

(57) ABSTRACT

This invention relates to cleaning and disinfection of apples and pears through the feed of aqueous blends of select disinfectant chemicals and select cleaning chemicals to provide simultaneous cleaning and sanitation on produce and food processing surfaces.

### FIELD OF THE INVENTION

This invention relates to simultaneous cleaning and disinfection blends of select disinfecting chemicals and cleaning chemicals, for improving the cleaning and sanitation of microbiologically contaminated fruit and fresh fruit packing surfaces. More specifically, this invention relates to a method for the simultaneous cleaning and disinfection of apple and pear fresh packing equipment surfaces which comprises blending at least one disinfectant chemical and at least one cleaning chemical into a water stream, or storage tank, and subsequently feeding this blended aqueous solution directly to the fruit as it passes along the packing line surfaces.

### RELATED REFERENCES

The process of cleaning and sanitation in a food processing facility typically involves a two-step process. First a cleaning chemical, such as a soap or surfactant, is applied to a food processing surface and a sufficient amount of contact time is provided for the cleaning chemical to breakdown, dissolve, or destroy the contaminants on the treated surfaces. After the cleaning chemical is washed off, the second step involves the application of a sanitizing chemical to the surfaces to provide disinfection, resulting in a reduction in the concentration of microbiological contaminants on the surface. The inventive blends identified in this disclosure reduce the two-step cleaning and sanitation process to a single step.

Other blends of sanitizer and cleaning chemical have been disclosed previously. A blended composition of sanitizer and detergent was taught in U.S. Pat. No. 3,929,661 A, comprising an alkaline aqueous solution of sodium hypochlorite, which solution contains a surfactant having the formula R2|R1-C—CH2OX|R3 wherein R1, R2 and R3, which can be the same or different, each is alkyl of 1 to 18 carbon atoms, the sum of the carbon atoms of R1, R2 and R3 being 10 to 20; and X is —SO3M, —CH2COOM, —CH2CH2COOM, —(CH2CH2O)nSO3M, or —(CH2CH2O)n-COOM, wherein n is an integer of 1 to 40 and M is an alkali metal. A disadvantage of the surfactants described in this invention is their poor biodegradability. U.S. Pat. No. 4,443,353 A teaches of a formulation containing an alkali metal hypochlorite, an alkaline agent, and one or more compounds of the general formula R—(OCH₂ CH₂)ₓ OCH₂ COOM, where R represents an alkyl group with 8-18 carbon atoms, x a number with an average value of 0.5-8 and a narrow distribution of the average value and M an alkali metal atom. In this application, the blended formulation is restricted to always be an alkaline formulation, which is very restrictive in various food processing applications. In either case, these inventions (U.S. Pat. No. 3,929,661 A and U.S. Pat. No. 4,443,353 A) involve the use of the hypochlorite ion or “chlorine”, which is a strong oxidizer and chlorinator, resulting in the formation of toxic and hazardous chlorinated disinfection by-products, such as trihalomethanes (i.e., chloroform) and halogenated acetic acid compounds. Other disinfectant chemicals, such as chlorine dioxide, are a much weaker oxidizing agent than the hypochlorite ion, making it less corrosive to surfaces, and the reaction of chlorine dioxide with organic contaminants does not result in the formation of toxic chlorinated disinfection by-products.

WO 2014089632 A1 describes the use of an aqueous disinfectant solution comprising peroxyacetic acid (PAA) and a surfactant such as a polyoxyethylene alkyl ether phosphate for disinfecting or sterilizing instruments, exposed surfaces, or spaces which may be infected with bacteria, fungi, viruses, fungal or bacterial spores, prions, and the like. The antimicrobial activity of chlorine dioxide at low dosages, such as 1-5 mg/L, is dramatically better than that of peroxyacetic acid even at dosages of 60-80 mg/L, making the applicability of WO 2014089632 A1 far less attractive than is being taught in this disclosure.

U.S. Pat. No. 5,611,938 teaches the application of biocidal blends comprising quaternary ammonium compounds and chlorine dioxide. This dual sanitizer approach is uniquely different from the inventive approach in this application, as it does not involve the use of a cleaning chemical. However, the simultaneous feed of a select cleaning chemical along with a blended sanitizer as taught in U.S. Pat. No. 5,611,938 is within the scope of this invention.

### BACKGROUND OF THE INVENTION

In the process of packing apples and pears, there is the cleaning and sanitation process that occurs every evening when the daily operation is completed, and the inventive blends described in this disclosure may certainly provide benefits in these processes, as they also would for any food processing industry. However, the primary focus of this disclosure is to address the cleaning and disinfection methods associated with the on-line, real-time processes that occur during the operations of apple and pear packing.

The current practice of cleaning and disinfection of the apples and pears is to:
1) transfer the fruit from storage bins to the processing line via a flume water system, called a dump tank, and;
2) pass the fruit over a bed of spinning brushes, allowing the brushes to polish any dirt and debris off the fruit surface, and to provide a shiny attractive surface.

The Stemilt Growers website (https://www.stemilt.com/farm-to-fork/farm-fork-apples/#1467860917366-f0293ff3-e83c) provides the following explanation in Step 1 of the apple packing process in which bins of apples are gently “dumped” into a recirculating flume water tank and transported “using chlorinated water to carry the delicate apples”. In Step 3 of the process the apples are passed along a spinning bed of brushes where they “are washed with food-grade soap and then rinsed with chlorinated water to clean orchard dirt and dust from the fruit.” A video from Domex SuperFresh Growers shows an actual packing line (https://www.youtube.com/watch?v=YAUeQHahUUs) with the apples passing through a dump tank flume water system, and across the brush bed, where they are cleaned and polished using a food-grade soap, rinsed with potable water, and dried under shear fans. The apples are wet when they enter the brush bed section of the line, and an aqueous cleaning chemical (soap) is applied to assist in the cleaning of the fruit, followed by a potable water rinse. After the rinse has been applied, the apples are dried and kept dry so that a wax can be applied to coat the fruit and provide an attractive polished surface. Therefore, it is the standard practice in the operational process of apple and pear packers to sequentially clean the fruit using a cleaning chemical (soap) and then to disinfect the fruit using a potable water rinse and/or a rinse that contains a sanitizer such as chlorine. More recently, the use of peroxyacetic acid (also called peracetic acid or PAA) has become the predominant choice as the final sanitizer rinse.

The problem with this method of cleaning and disinfecting apples and pears is that the decay-causing microorganisms and pathogenic microorganisms that are on the fruit can be transferred into the bristles of the brushes all along the brush bed, allowing for inoculation of the bristles. Subsequently, healthy fruit that passes along these contaminated brushes can become contaminated and inoculated. Application of a cleaning chemical, such as a soap or detergent formulation containing one or more surfactant-type compounds, effectively dislodges dirt, debris, and microorganism colonies from the surface of the fruit, allowing the microorganisms to be dispersed throughout the brushes within the brush bed section of the packing line. Microbiological testing of the surface of apples prior to entering the brush bed section and at the end of the brush bed section shows dramatic increases in microbiological contamination on the apples at the end of the brush bed. For example, a microbiological test was performed on apples passing along an apple packing line, using Biosan Laboratories (1950 Tobsal Ct, Warren, Mich. 48091) Sani-Check BF dipslides capable of detecting the growth of total aerobic bacteria on apple surfaces. Apples used in the test were from a select grouping of bins of apples from a select grower in Washington State. The testing procedure involved extracting five apples from a specific location along the packing line, submerging those five apples in one liter of distilled water within a one gallon ziplock bag, shaking the bag for 30 seconds, and sampling the water with a Sani-Check BF dipslide. Three days after the procedure was performed the microbiological colonies were quantified and reported, providing the following information in colony forming units (CFU) per milliliter (mL):

| | Total Aerobic |
|---|---|
| Sample Location | Bacteria (CFU/mL) |
| Apples pulled from the storage bin | ~10⁶ |
| Apples after the dump tank, pulled from the pre-sort | ~10² |
| table | |
| Apples pulled after the final sanitizer (PAA) rinse | ~10⁵ |

These results demonstrate how microbiological contamination on the apples can vary across the packing line. In this experiment, apples obtained directly from the storage bin prior to being immersed in the dump tank flume water system, were heavily contaminated with bacteria (about 10⁶ CFU/mL). After transporting the apples through the dump tank flume water system, the apples were elevated out of the flume via a “roller conveyor”. For reference to this process, refer to the previously mentioned video from Domex SuperFresh Growers (https://www.youtube.com/watch?v=YAUeQHghUUs between the 0:40 second and 1:10 second portion of the video. The dump tank flume water system that was used for the above reference experiment was treated with calcium hypochlorite (referred to as “chlorine’) and the water was maintained at a pH around 7.0 and with an ORP (oxidation-reduction potential) reading of about 750 mV. The apples then passed across a pre-sort table in which the obvious “off-spec” apples were removed from the line. Microbiological sampling of the apples pulled from the pre-sort table, just prior to their entrance onto the brush bed, showed a dramatic reduction in contamination (about 10² CFU/mL) as compared to the contamination present on the same apples in the storage bins, indicating the effectiveness of the chlorine treatment in the dump tank flume water system.

Once the apples moved from the pre-sort table onto the brush bed, a cleaning chemical (soap) was applied. The apples were transported along the brush bed for approximately 15-20 feet, constantly spinning as the brushes and soap polished the apple surfaces, until the apples reached the bank of spray bars. Four consecutive spray bars of potable water were stationed with about 18 inches of separation between the bars. The potable water was treated with 60-80 ppm of PAA sanitizer to enhance the disinfection of the fruit.

The actual length of the soapy portion of a brush bed can vary from packing house to packing house, depending on factors as simple as space constraints within the building or as complex as philosophies about the damaging effects of too much brushing on the surface of the fruit. In this case, the length of the soapy portion of a brush bed was about 15-20 feet.

In some cases, the sanitizer chemical being added to a spray bar must be rinsed off of the fruit using untreated potable water, resulting in the need for separate sanitizer and rinse spray bars. In this case, the sanitizer spray bar is located immediately in front of the potable water rinse bar. Therefore, in a typical brush bed chemical treatment application the soap is applied first, followed by the sanitizer, and finally the potable water rinse. In some cases, as with the use of peroxyacidic acid (PAA), it is acceptable for an FDA-approved sanitizer to be applied directly into the final potable water rinse bar, negating the need for a separate sanitizer spray bar.

Numerous disinfectants, such as chlorine, chlorine dioxide, ozone, PA, and quaternary ammonium compounds (quats) have been used in the spray bar rinse water to reduce microbiological cortamination on the fruit. However, this practice results in only moderate reductions in microbiological cortamination on the fruit, primarily because there is a very short contact time for the spray bar rinse water with the fruit. Referencing back to the results from the experiment in the table above, microbiological sampling of the apples immediately alter the sanitizer spray bars (in which a dose of 60-80 ppm of PAA was applied in four adjacent spray bars) showed that the microbiological cortamination on the apples (˜10⁵ cfu/mL) was only slightly less than that on the apples tested directly from the bin (˜10° cfu/mL). Therefore, the reduction in microbiological contamination achieved by the dump tank was lost when the apples travelled across the contaminated brushes of the brush bed. Again, this is not surprising due to the action of the soap to 1) dislodge dirt, debris and microorganisms from the surface of contaminated fruit, 2) spread the inoculun across the entire brush bed, and 3) infect clean, healthy fruit. Thus, the disinfectant applied in the final rinse bars provided only a minor benefit, resulting in apples that though they had been washed, cleaned, and rinsed, have only moderately reduced microbiological contamination as compared to those same apples when they stil resided in the storage bin. For this reason, apple packers have begun to add additional disinfectant spray bars at the end of their brush bed. Therefore, instead of using only one or two spray bars, they may increase to four or eight spray bars, thereby increasing the contact time of the disinfectant on the fruit. This practice, of course, results in a dramatic increase in the overall usage of water and chemical by the facility, which is counterproductive both economically and envionmertally.

Inoculation of clean, healthy fruit with decay microorganisms, such as blue mold (Penicillium expansum), gray mold (B. cinerea), Sphaeropsis rot, bull's eye rot (species of Neofabraea), or mucor rot (Mucor piriformis) can result in dramatic financial losses in production due to decreased shelf-life.

Inoculation of clean, healthy fruit with pathogenic, food-safety microorganisms, such as Salmonella, E. Coli, and Listeria monocytogenes can result in serious illness or death to those handling or eating the food. For more information about the effect of food safety pathogens, see https://www.foodsafety.gov/poisoning/causes/bacteriaviruses/. In January of 2015, an outbreak was reported, stemming from Listeria monocytogenes-contaminated caramel apples from an apple packing facility supplying to the caramel apple producer. A total of 35 infected people was reported from 12 states. Of these, 34 people were hospitalized. Listeriosis contributed to at least three of the seven deaths reported. See https://www.cdc.gov/listeria/outbreaks/caramel-apples-12-14/ for more information on this outbreak.

With the increased focus on food safety in the industry, apple and pear packing facilities have been researching how to best minimize the risk of inoculation to the fruit and packing line surfaces. To date, known research has strictly involved the application of various disinfectant chemicals into the final spray bar rinse water after the cleaning chemical (soap) has already performed its task of dislodging debris and microorganisms along the brush bed section of the packing line. As mentioned previously, use of a disinfectant chemical in the spray bar rinse water only provides a marginal reduction in microorganism populations on the fruit, and addition of multiple spray bars results in excessive water and chemical usage. Therefore, there is a need to improve the overall application of disinfectant chemicals in order to minimize the microbiological contamination on the produce being cleaned and packaged, as well as to minimize the microbiological contamination associated with the food processing equipment surfaces that are in direct contact with the produce.

### DETAILED DESCRIPTION OF THE INVENTION

This invention relates to a method of blending cleaning and disinfection chemicals prior to an application point, thus benefiting from the activity of such blends for improved cleaning and sanitation of microbiologically contaminated surfaces. More specifically, this invention relates to a method for the simultaneous cleaning and disinfection of apples and pears, and the fresh packing equipment surfaces that they pass over, which comprises adding a blend of a disinfecting chemical and a cleaning chemical directly to the fruit as it passes along the packing line surfaces. While the description of the activity of the aqueous blends of disinfecting chemicals and cleaning chemicals is predominantly focused on the apple and pear packing processes, it should be recognized that the benefits of application of these aqueous blends of disinfecting chemicals and cleaning chemicals can be realized in other food processing applications.

Not every disinfectant can be blended with every cleaner. Many disinfectants are strong oxidizing agents, such as chlorine which reacts with known commercially available FDA-approved surfactant chemicals to cause destruction of the disinfectant and a reduction in the available surfactant chemical useful for cleaning. Various forms of “chlorine”, such as Cl₂, NaOCl, Ca(OCl)₂, and others, react with organic molecules to generate toxic chlorinated by-products called THMs (trihalomethanes) and HAAs (halogenated acetic acid). It is the goal of this invention for the selected disinfectant to have a minimal reactivity with the cleaning chemical, so that the maximum effect of the disinfectant will be directed toward reducing microbiological contamination in the fruit and packing line surfaces that it encounters.

Some disinfectants, such as hydrogen peroxide, do not possess the necessary reactivity to provide effective antimicrobial performance in the short amount of time afforded in the soapy section of the apple packing brush bed. Therefore, thoughtful consideration is needed to identify select disinfectants and select cleaning chemicals for optimal antimicrobial reactivity and stability properties in order to achieve the desired results for optimal cleaning and sanitation.

There are many occasions in the processing and packing of fresh apples and pears when the fruit coming in from the orchard is coated with a layer of mineral scale (i.e., calcium carbonate). This occurs in orchards that use overhead spray irrigation to cool the apples (minimizing the effects of sunburn) as well as to water the tree. When the water on the fruit dries, it can leave behind a coating of scale. Therefore, under such conditions, it is common for the apple or pear packing facility to apply a cleaning chemical to the fruit as they are being polished on the brush bed that has an acidic formulation, consisting of chemicals such as citric acid, phosphoric acid, EDTA (Ethylene diamine tetraacetic acid), DDBSA (dodecylbenzenesulfonic acid), or other acid-based surfactant chemicals, and mixtures thereof.

Under other conditions, such as when there is a need to remove the existing natural wax coating on an apple, the desired cleaning chemical is one with an alkaline formulation, consisting of chemicals such as sodium hydroxide, potassium hydroxide, sodium carbonate, potassium carbonate, sodium bicarbonate, sodium metasilicate, sodium tripolyphosphate, sodium dodecylbenzene sulfonate, and other alkaline-based surfactant chemicals, and mixtures thereof.

Under still other conditions, the desired cleaning chemical is one with a neutral formulation, consisting of surfactants such as ethoxylated secondary alcohols (C11-15) (called Fruit & Vegetable Kleen 340 from DECOO), polysorbates (called Tween and Span), oligomeric alkypoly(ethyleneoxides) (called Brij and Tergitol), and other neutral surfactant chemicals, and mixtures thereof.

The selection of cleaning chemical formulations for the various cleaning purposes associated with this application is within the known skilled art of the apple and pear fresh packing industry. However, the proper selection of the disinfectant to be blended with each possible cleaning chemical formulation is not well known in the art. In general, selection of a disinfectant chemical that is a weaker oxidizing agent than other possible disinfectants is preferred. For this reason, sodium chlorite and chlorine dioxide, which are weaker oxidizing agents than other disinfectants, such as ozone, hydrogen peroxide, and chlorine (bleach), are the most preferred disinfectants for the purpose of maximizing the overall benefits from being blended with the desired cleaning chemical prior to being applied to a food or food processing surface.

More specifically, this application teaches a method for cleaning and disinfecting apples and pears in a fresh packing process, in which at least one disinfectant chemical and at least one cleaning chemical are fed into a flowing water line, or storage tank, to create a blended treated water containing a desired dose of the disinfectant chemical and the at least one cleaning chemical within the treated water, said treated water then being directed to one or more distinct feed points along the apple or pear fresh pack processing line and delivered onto the produce and the food contact surfaces associated with that line, wherein the disinfectant chemical consists of sodium chlorite or chlorine dioxide.

The cleaning chemical can be selected from a broad range of potential cleaning chemicals, most specifically from the groups consisting of:
an acidic formulation, consisting of chemicals such as citric acid, phosphoric acid, EDTA (Ethylene diamine tetraacetic acid), DDBSA (dodecylbenzenesulfonic acid), or other acid-based surfactant chemicals, and mixtures thereof.
an alkaline formulation, consisting of chemicals such as sodium hydroxide, potassium hydroxide, sodium carbonate, potassium carbonate, sodium bicarbonate, sodium metasilicate, sodium tripolyphosphate, sodium dodecylbenzene sulfonate, and other alkaline-based surfactant chemicals, and mixtures thereof.
a neutral formulation, consisting of surfactants such as ethoxylated secondary alcohols (C11-15) (called Fruit & Vegetable Kleen 340 from DECOO), polysorbates (called Tween and Span), oligomeric alkypoly(ethyleneoxides) (called Brij and Tergitol), and other neutral surfactant chemicals, and mixtures thereof.

Within the scope of this application, the method can be expanded to include the further blending of at least one additional disinfectant chemical into the treated flowing water line, or storage tank, wherein the additional disinfectant chemical is selected from the group consisting of peroxyacetic acid, sodium hypochlorite, calcium hypochlorite, BCDMH (bromo-chloro-dimethylhydantoin), iodine, and quatemary ammonium compounds.

In like fashion, this method for cleaning and disinfecting apples and pears in a fresh packing process can be employed in which the selected disinfectant is a quaternary ammonium compound, to be blended with at least one cleaning chemical and fed into a flowing water line, or storage tank, to create a blended treated water containing a desired dose of the quaternary ammonium compound and the at least one cleaning chemical within the treated water, said treated water then being directed to one or more distinct feed points along the apple or pear fresh pack processing line and delivered onto the produce and the food contact surfaces associated with that line.

Quaternary ammonium compounds that are effective antimicrobials within the scope of this invention are selected from the group consisting of benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, domiphen bromide, and other similar quaternary ammonium compounds, especially those containing long alkyl chains.

There are certain highly effective applications of this method that involve the blending of two disinfectants along with at least one cleaning chemical formulation. One such method for cleaning and disinfecting apples and pears in a fresh packing process involves the blending of sodium chlorite, peroxyacetic acid, and at least one cleaning chemical into a flowing water line, or storage tank, to create a blended treated water containing a desired dose of the sodium chlorite, peroxyacetic acid, and the at least one cleaning chemical within the treated water, said treated water then being directed to one or more distinct feed points along the apple or pear fresh pack processing line and delivered onto the produce and the food contact surfaces associated with that line. In this method, the acidity of the PAA facilitates the transformation of chlorite into chlorine dioxide (ClO₂), which is a highly potent disinfectant even at very low dosages. For this application of the blend of sodium chlorite and PAA, the cleaning chemical can be selected from the groups consisting of:
an acidic formulation, consisting of chemicals such as citric acid, phosphoric acid, EDTA (Ethylene diamine tetraacetic acid), DDBSA (dodecylbenzenesulfonic acid), or other acid-based surfactant chemicals, and mixtures thereof.
a neutral formulation, consisting of surfactants such as ethoxylated secondary alcohols (C11-15) (called Fruit & Vegetable Kleen 340 from DECOO), polysorbates (called Tween and Span), oligomeric alkypoly(ethyleneoxides) (called Brij and Tergitol), and other neutral surfactant chemicals, and mixtures thereof.
Another method for cleaning and disinfecting apples and pears in a fresh packing process involves the blending of sodium chlorite, a quaternary ammonium compound, and at least one acidic cleaning chemical into a flowing water line, or storage tank, to create a blended treated water containing a desired dose of the sodium chlorite, a quaternary ammonium compound, and the at least one acidic cleaning chemical within the treated water, said treated water then being directed to one or more distinct feed points along the apple or pear fresh pack processing line and delivered onto the produce and the food contact surfaces associated with that line. In this method, the acidity of the cleaning chemical facilitates the transformation of chlorite into chlorine dioxide (ClO₂). For this application of the blend of sodium chlorite and a quaternary ammonium compound, the acidic cleaning chemical can be selected from the groups consisting of citric acid, phosphoric acid, EDTA (Ethylene diamine tetraacetic acid), DDBSA (dodecylbenzenesulfonic acid), or other acid-based surfactant chemicals, and mixtures thereof.

Still another method for cleaning and disinfecting apples and pears in a fresh packing process involves the blending of chlorine dioxide (ClO₂), a quaternary ammonium compound, and at least one cleaning chemical into a flowing water line, or storage tank, to create a blended treated water containing a desired dose of the ClO₂, a quatemary ammonium compound, and the at least one cleaning chemical within the treated water, said treated water then being directed to one or more distinct feed points along the apple or pear fresh pack processing line and delivered onto the produce and the food contact surfaces associated with that line. In this method, the cleaning chemical can be selected from the groups consisting of:
an acidic formulation, consisting of chemicals such as citric acid, phosphoric acid, EDTA (Ethylene diamine tetraacetic acid), DDBSA (dodecylbenzenesulfonic acid), or other acid-based surfactant chemicals, and mixtures thereof.
an alkaline formulation, consisting of chemicals such as sodium hydroxide, potassium hydroxide, sodium carbonate, potassium carbonate, sodium bicarbonate, sodium metasilicate, sodium tripolyphosphate, sodium dodecylbenzene sulfonate, and other alkaline-based surfactant chemicals, and mixtures thereof.
a neutral formulation, consisting of surfactants such as ethoxylated secondary alcohols (C11-15) (called Fruit & Vegetable Kleen 340 from DECOO), polysorbates (called Tween and Span), oligomeric alkypoly(ethyleneoxides) (called Brij and Tergitol), and other neutral surfactant chemicals, and mixtures thereof.

### Examples

The following examples employ blends of disinfectants with specific food grade cleaners from a company called DECCO (DECCO US Post-Harvest, Inc., 1713 S. California Ave. Monrovia, Calif. 91016). However, cleaner formulas, surfactant formulas, and detergent formulas from other manufacturers/distributors, such as Ecolab (370 Wabasha St N, Saint Paul, Minn. 55102), Pace International (5661 Branch Rd, Wapato, Wash. 98951), or Wesmar Company (5720 204th St SW, Lynnwood, Wash. 98036), could have equally been selected for such examples. In addition, these examples highlight various blends with sodium chlorite and chlorine dioxide with PAA; however, similar blends can be formulated with these same cleaning products by replacing PAA with a quaternary ammonium compound.
1. Disinfectant blended with an acidic cleaner from DECCO−KLEEN PAC AC (which contains a blend of sulfonic acid and citric acid):
Chlorine Dioxide+KLEEN PAC AC
Sodium Chlorite+KLEEN PAC AC
2. Two disinfectants blended with an acidic cleaner from DECCO−KLEEN PAC AC (which contains a blend of sulfonic acid and citric acid):
Chlorine Dioxide+Peroxyacetic Acid+KLEEN PAC AC
Sodium Chlorite+Peroxyacetic Acid+KLEEN PAC AC
3. Disinfectant blended with a different acidic cleaner from DECCO APL-KLEEN→246 (which contains a blend of phospshoric acid, DDBSA, and propylene glycol blend):
Chlorine Dioxide+APL-KLEEN→246
Sodium Chlorite+APL-KLEEN→246
4. Two disinfectants blended with a different acidic cleaner from DECCO APL-KLEEN→246 (which contains a blend of phospshoric acid, DDBSA, and propylene glycol blend):
Chlorine Dioxide+Peroxyacetic Acid+APL-KLEEN→246
Sodium Chlorite+Peroxyacetic Acid+APL-KLEEN→246
5. Disinfectant blended with an alkaline cleaner from DECCO FRUIT & VEGETABLE KLEEN→241 (which contains sodium dodecylbenzene sulfonate):
Chlorine Dioxide+FRUIT & VEGETABLE KLEEN→241
6. Two disinfectants blended with an alkaline cleaner from DECCO FRUIT & VEGETABLE KLEEN→241 (which contains sodium dodecylbenzene sulfonate):
Chlorine Dioxide+Peroxyacetic Acid+FRUIT & VEGETABLE KLEEN→241

Etc.

Food-grade cleaning chemicals were selected from DECCO simply because the DECCO website provided the chemical compositional information in the formulations to allow for best understanding of the successful blending of these cleaners with select disinfectants. Therefore, the choice to use cleaners from DECCO in the above examples is not intended to limit in any way the blending of select disinfectants with other cleaning chemicals from other sanitation companies, such as Ecolab, Pace International, or Wesmar Company, or any other company that provides an approved food-grade cleaner or soap or detergent or surfactant chemical or similar formulation for the food processing market, and, more specifically, for the apple and pear packing market.

Note that Examples #1 through #4 describe blends of sodium chlorite with acidic cleaners, while in Examples #5 and #6 there was no mention of a blend of sodium chlorite with the alkaline cleaner. When an acidic cleaner is being used, as in Examples #1 through #4, the pH of the aqueous environment that is present on the food processing equipment will be acidic. In an acidic environment, for instance the environment created between the bristles of an apple packing brush bed treated with an acidic soap, the chemical conversion of sodium chlorite into chlorine dioxide (ClO₂) occurs in-situ, resulting in the generation of ClO₂ within the aqueous soap mixture entrained within the brush bed bristles. Likewise, though to a lesser extent, when a pH neutral cleaner is being used, the natural acidity of the produce (for instance, apples) will result in a slightly acidic environment that will also foster the generation of ClO₂ from the feed of sodium chlorite. The flowing chemical equation describes the reaction between sodium chlorite (NaClO₂) and an acid (shown as the hydrogen cation, H*):

5NaClO₂+4H⁺→NaCl+4ClO₂+2H₂O+4Na⁺

The use of various acids to generate chlorine dioxide from sodium chlorite is well known in the chemical and medicinal field. For instance, using hydrochloric acid (HCl) results in the following chemical equation:

5NaClO₂+4HCl→5NaCl+4ClO₂+2H₂O

Other inventive blends include those in which sodium chlorite can be blended into the spray bar rinse water line with peroxyacetic acid (PAA) and an acidic cleaner, in which the acidity of the PAA and the acidic cleaner will convert the sodium chlorite into chlorine dioxide as the entire mixture resides in contact with the produce and food processing equipment, and, more specifically, within the bristles of an apple or pear packing line brush bed.

Other inventive blends include those in which sodium chlorite can be blended into the spray bar rinse water line with a quaternary ammonium sanitizer and an acidic cleaner.

Still other inventive blends include those in which chlorine dioxide can be blended into the spray bar rinse water line with a quaternary ammonium sanitizer and an alkaline cleaner.

Another inventive blend includes those in which chlorine dioxide can be blended into the spray bar rinse water line with peroxyacetic acid (PAA) and an alkaline cleaner.

How the Invention Works:

In its simplest form, the invention works by feeding an aqueous stream of a disinfectant chemical into an aqueous stream of a cleaning chemical, blending them together into a single aqueous stream, or storage tank, that is then fed to one or more food processing surfaces containing produce. More specifically for the apple and pear fresh packing industry, the invention works by feeding the blended stream of disinfectant and cleaner to a spray bar, drip bar, rain pan, water curtain, or flood box, introducing this aqueous blended treatment simultaneously to the fruit, brush bed, and associated food processing equipment along the brush bed section of an apple or pear packing line. Depending on the length of the “soap section” of the brush bed, two or more application points (spray bar, drip bar, rain pan, or flood box) can be added. The primary mechanism for blending the disinfectant and cleaner is via chemical metering pumps.

Incorporating a second disinfectant into the already blended mixture that contains a first disinfectant and the cleaning chemical can simply involve feeding an aqueous stream of the second disinfectant, via a separate chemical metering pump, into the single aqueous stream already containing the first disinfectant and the cleaner. Alternatively, the second disinfectant can be fed into the aqueous stream containing the cleaner at a point prior to that of where the first disinfectant is being fed—i.e., order of addition of the disinfectants is not important for changing or optimizing product performance. Finally, one of the two disinfectants can be fed into the water line prior to the addition of the cleaner, which can then be followed by addition of the second disinfectant—i.e., order of addition of the cleaner and disinfectants is not important for changing or optimizing performance.

In the actual application of this invention, the primary method for chemical delivery is via metering pumps set at the proper feed rate of each chemical additive (disinfectant or cleaner) in order to deliver the necessary concentrations of each additive into the single blended water stream to achieve optimum cleaning and disinfection performance. As a secondary method for chemical delivery, the cleaner and disinfectant chemicals can be fed into a flowing water line using an eductor (venturi) to create the blended stream. Finally, a third method for chemical delivery is to feed the necessary amount of each cleaner and disinfectant into a water storage tank and then pumping this treated water to the desired feed point(s). However, due to the increased contact time within the storage tank, care must be taken to ensure that the disinfectant and cleaner chemicals do not react with each other in the storage tank, thus reducing the performance activity of each component in the blend prior to being fed to the brush bed or other sections of the processing line.

For cases in which chlorine dioxide is used as a disinfectant, the on-site generation of chlorine dioxide can be performed using one of any number of well-known methods, such as:
reducing sodium chlorate in a strong acid solution with a suitable reducing agent such as methanol or hydrogen peroxide (predominantly used for pulp bleaching).
using a “three-chem” method of blending sodium chlorite, sodium hypochlorite, and hydrochloric acid:

2NaClO₂+2HCl+NaOCl→2ClO₂+3NaCl+H₂O
using a “two-chem” method of blending sodium chlorite with an acid, such as hydrochloric acid:

5NaClO₂+4HCl→5NaCl+4ClO₂+2H₂O
using an electrolytic “one-chem” method involving electrolysis of a chlorite solution:

2NaClO₂+2H₂O→2ClO₂+2NaOH+H₂

In the case where an electrolytic “one-chem” method is employed for ClO₂ generation, this method produces two product streams, one containing ClO₂ and the other containing sodium hydroxide (NaOH). The stream containing ClO₂ will be used as the disinfectant stream. The stream that contains NaOH can be fed into the soap line for those instances when an alkaline cleaner is being employed. Otherwise, it can be fed to the drain.

There are many reports of the limited and selective reaction chemistry of chlorine dioxide with organic molecules, some of which are referenced below:
C. Rav-Acha, “The Reactions of Chlorine Dioxide with Aquatic Organic Materials and Their Health Effects”, Water Res., 18 (11), 84, 1984.
W. J. Masschelein, “The State of Art in the Use of Chlorine Dioxide and Ozone in the Treatment of Water,” Water SA, 6(3), 116-129, 1980.
M. G. Noak, and R. L. Doerr, “Chlorine Oxygen Acids and Salts—Chlorine Dioxide, Chlorous Acid, and Chlorites,” Kirk-Othmer Encycl. Chem. Technol., 3rd Ed., Volume 5, 612-632, 1979.

For instance, sodium hypochlorite reacts with ammonia or amines, while chlorine dioxide reacts very slowly with secondary amines, and not at all with primary amines or ammonia. Finally, while chlorine and bromine react with organic molecules to primarily attached a chlorine or bromine atom to the organic molecule, resulting in the formation of a toxic halogenated hydrocarbon, chlorine dioxide primarily reacts via an oxidation mechanism in which the oxygen atom from ClO₂ is added to the organic molecule, resulting in no increase in toxicity related to disinfection by-products from the use of ClO₂.

Because of the limited reaction of ClO₂ with organic contaminants, a high percentage of the chlorine dioxide added to the brush bed section of the packing line remains available for an extended period of time as an active antimicrobial agent, and is not rapidly consumed to the degree that chlorine, bromine, PAA, or ozone would be under the same circumstances. Also, when ClO₂ reacts with organic molecules, one of the by-products is chlorite, which is the precursor for the re-generation of ClO₂. Therefore, in the presence of an acidic soapy environment, there will be a cycling of ClO₂ to chlorite and back to ClO₂ that will extend the disinfection performance of ClO₂ farther down the brush bed. For these reasons, sodium chlorite and chlorine dioxide are the preferred disinfectants for this inventive method.

The actual practice of the invention can be accomplished using chemical metering pumps with individual feed lines connected to each disinfectant chemical and cleaning chemical being employed, with these feed lines being connected to a water line that carries the desired concentrations of the blended disinfectant-cleaner formula to the brush bed feed point (spray bar, drip bar, rain pan, or flood box) or any other application point along the processing line.

The necessary elements of this invention are the individual chemical storage tanks (drums, IBC totes, bulk tanks, etc.) that hold the disinfectant(s) and cleaning chemical(s), the individual feed lines that connect the disinfectant line(s) and cleaning chemical line(s) to the single water line that delivers the mixture to the desired food processing line application feed points, such as to the brush bed of an apple or pear fresh packing line.

Optional components are the individual chemical metering pumps for each chemical. Alternatively, eductors (venturi) can be used in lieu of pumps to deliver the appropriate concentrations of chemicals into the water line.

The order of addition of the disinfectant(s) or cleaner is not important for changing or optimizing product performance, so long as the disinfectant chemical(s) and cleaning chemical are properly mixed at the desired dosage of each component.

This invention can be used in fruit and vegetable packing applications other than just apple and pear packing, such as in cherry packing, onion packing, potato packing, in washing of leafy greens, kiwis, tomatoes, and in any food processing application that uses rinse water in direct contact with the food product or produce.

While various embodiments of the invention have been described, as noted above, many changes can be made without departing from the spirit and scope of the invention. Accordingly, the scope of the invention is not limited by the disclosure of the preferred embodiment. Instead, the invention should be determined entirely by reference to the claims that follow.

I claim:

1. A method for cleaning and disinfecting apples and pears in a fresh packing process, in which at least one disinfectant chemical and at least one cleaning chemical are fed into a flowing water line, or storage tank, to create a blended treated water containing a desired dose of the at least one disinfectant chemical and the at least one cleaning chemical within the treated water, said treated water then being directed to one or more distinct feed points along the apple or pear fresh pack processing line and delivered onto the produce and the food contact surfaces associated with that line, wherein the disinfectant chemical consists of chlorine dioxide, a quaternary ammonium compound, or peroxyacetic acid.

2. A method according to claim 1 in which the cleaning chemical can be selected from the groups consisting of:
an acidic formulation, consisting of chemicals such as citric acid, phosphoric acid, EDTA (Ethylene diamine tetraacetic acid), DDBSA (dodecylbenzenesulfonic acid), or other acid-based surfactant chemicals, and mixtures thereof.
an alkaline formulation, consisting of chemicals such as sodium hydroxide, potassium hydroxide, sodium carbonate, potassium carbonate, sodium bicarbonate, sodium metasilicate, sodium tripolyphosphate, sodium dodecylbenzene sulfonate, and other alkaline-based surfactant chemicals, and mixtures thereof.
a neutral formulation, consisting of surfactants such as ethoxylated secondary alcohols (C11-15) (called Fruit & Vegetable Kleen 340 from DECOO), polysorbates (called Tween and Span), oligomeric alkypoly(ethyleneoxides) (called Brij and Tergitol), and other neutral surfactant chemicals, and mixtures thereof.

3. A method according to claim 1 in which at least one additional disinfectant chemical is fed into a flowing water line, or storage tank, wherein the additional disinfectant chemical is selected from the group consisting of peroxyacetic acid, sodium hypochlorite, calcium hypochlorite, BCDMH (bromo-chloro-dimethylhydantoin) iodine, and quaternary ammonium compounds.

4. A method according to claim 1 in which quaternary ammonium compounds that are effective antimicrobials within the scope of this invention are selected from the group consisting of benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, domiphen bromide, and other similar quaternary ammonium compounds, especially those containing long alkyl chains.

5. A method for cleaning and disinfecting apples and pears in a fresh packing process, in which sodium chlorite, peroxyacetic acid, and at least one cleaning chemical are fed into a flowing water line, or storage tank, to create a blended treated water containing a desired dose of the sodium chlorite, peroxyacetic acid, and the at least one cleaning chemical within the treated water, said treated water then being directed to one or more distinct feed points along the apple or pear fresh pack processing line and delivered onto the produce and the food contact surfaces associated with that line.

6. A method according to claim 5 in which the cleaning chemical can be selected from the groups consisting of:
an acidic formulation, consisting of chemicals such as citric acid, phosphoric acid, EDTA (Ethylene diamine tetraacetic acid), DDBSA (dodecylbenzenesulfonic acid), or other acid-based surfactant chemicals, and mixtures thereof.
an alkaline formulation, consisting of chemicals such as sodium hydroxide, potassium hydroxide, sodium carbonate, potassium carbonate, sodium bicarbonate, sodium metasilicate, sodium tripolyphosphate, sodium dodecylbenzene sulfonate, and other alkaline-based surfactant chemicals, and mixtures thereof.
a neutral formulation, consisting of surfactants such as ethoxylated secondary alcohols (C11-15) (called Fruit & Vegetable Kleen 340 from DECOO), polysorbates (called Tween and Span), oligomeric alkypoly(ethyleneoxides) (called Brij and Tergitol), and other neutral surfactant chemicals, and mixtures thereof.

7. A method for cleaning and disinfecting apples and pears in a fresh packing process, in which sodium chlorite and at least one acidic cleaning chemical are fed into a flowing water line, or storage tank, to create a blended treated water containing a desired dose of the sodium chlorite and the at least one acidic cleaning chemical within the treated water, said treated water then being directed to one or more distinct feed points along the apple or pear fresh pack processing line and delivered onto the produce and the food contact surfaces associated with that line, wherein the acidic cleaning chemical can be a formulation consisting of chemicals such as citric acid, phosphoric acid, EDTA (Ethylene diamine tetraacetic acid), DDBSA (dodecylbenzenesulfonic acid), or other acid-based surfactant chemicals, and mixtures thereof.

8. A method for cleaning and disinfecting apples and pears in a fresh packing process, in which sodium chlorite, a quaternary ammonium compound, and at least one acidic cleaning chemical are fed into a flowing water line, or storage tank, to create a blended treated water containing a desired dose of the sodium chlorite, quaternary ammonium compound, and the at least one acidic cleaning chemical within the treated water, said treated water then being directed to one or more distinct feed points along the apple or pear fresh pack processing line and delivered onto the produce and the food contact surfaces associated with that line, wherein the acidic cleaning chemical can be a formulation consisting of chemicals such as citric acid, phosphoric acid, EDTA (Ethylene diamine tetraacetic acid), DDBSA (dodecylbenzenesulfonic acid), or other acid-based surfactant chemicals, and mixtures thereof.

9. A method for cleaning and disinfecting apples and pears in a fresh packing process, in which chlorine dioxide, a quaternary ammonium compound, and at least one cleaning chemical are fed into a flowing water line, or storage tank, to create a blended treated water containing a desired dose of the chlorine dioxide, quaternary ammonium compound, and the at least one cleaning chemical within the treated water, said treated water then being directed to one or more distinct feed points along the apple or pear fresh pack processing line and delivered onto the produce and the food contact surfaces associated with that line.
